(19) United States
(12) Patent Application Publication
(10) Pub. No.: US 2002/0186366 A1
(43) Pub. Date: Dec. 12, 2002

(54) Apparatus and method of monitoring and controlling power output of a laser system

(76) Inventors: Robert M. Trusty, Cincinnati, OH (US); Scott Allen Nield, Reading, OH (US); William Conrad Stenton, Midland (CA); John W. Bowron, Penetanguishene (CA); John Robert Pursel, Victoria Harbor, CA (US)

Correspondence Address: James P. Davidson, DAVIDSON & GRIBBELL, LLP, 10250 Alliance Road, Suite 120, Cincinnati, OH, 45242, US

(21) Appl. No.: 09/877,275

(22) Filed: Jun. 8, 2001

(51) Int. Cl. G01B 11/26; G01C 1/00

(52) U.S. Cl. 356/139.06; 356/139.05; 356/139.07

(57) ABSTRACT

An optical bench for processing laser light in a laser system, including an optical bench housing, steering optics mounted within the optical bench housing for directing the laser light in a path from a laser light input to an output, and a first mechanism for monitoring power output of the laser light regardless of shifts in wavelength of the laser light. The steering optics includes a sampling filter mounted to the optical bench housing and positioned in the path of the laser light, wherein a first portion of the laser light is reflected to the output and a second portion of the laser light is transmitted to the first mechanism. The first mechanism further includes a correction filter for receiving the second laser light portion from the sampling filter, wherein a third portion of the laser light transmitted therethrough is adjusted to compensate for the wavelength shifts, and a power detector for receiving the third laser light portion and providing a signal representative of a detected power output of the laser light. The optical bench also may include a second mechanism for maintaining the power output of the laser light at a desired power output level.

### BACKGROUND OF THE INVENTION

The present invention relates to an optical bench for a laser system and, more particularly, to a mechanism for monitoring power output of laser light being processed in an optical bench regardless of shifts in wavelength and fluctuations in diode temperature.

It is well known that energy generators in the form of laser systems have been utilized to treat many disease states through surgical procedures. Such laser systems typically have a control loop provided therein to monitor and control the output power thereof since the Federal Drug Administration requires that power control accuracy be within 20% of the value displayed by the instrument. In performing this task, a small portion of light energy (approximately 1%) is typically removed from the laser beam by means of a beamsplitter or similar device so as to maximize the usable energy of the laser beam.

It will be appreciated that many laser systems utilize diodes to produce the desired laser beam and an optical bench for coupling the laser energy into a treatment fiber. Laser diodes have a characteristic, however, which can create differences between the monitored output power of the laser light and the output power actually produced therefrom. More specifically, such laser diodes emit light in a wavelength that varies with the temperature thereof. Since diode-based laser systems are known to be relatively inefficient in converting electrical energy into optical power, the system loses energy in the form of heat. This heat is generally pumped away from the laser diode by using active cooling and a heat sink, for example, but some residual heat causes the diode junction temperature to vary from the time of start-up to steady state operation.

The aforementioned beamsplitter, in turn, may vary in its transmission and reflection percentages of light impinging on it as a function of the wavelength for such light. Due to the small percentage of light used for power monitoring, the percentage change of transmitted light becomes very sensitive to wavelength fluctuations so that even small variations in wavelength can cause changes in transmitted light to become greatly amplified. For example, a wavelength shift that causes only a 0.5% change in the reflected light from a beamsplitter (i.e., from 99% to 99.5%) causes a fifty percent drop in the transmitted light energy (i.e., from 1% to 0.5%). This can obviously have a drastic effect on the output power detected within the optical bench even though the actual output power of the laser beam is unaffected.

In light of the foregoing concerns, as well as the continued need for monitoring and controlling output power in laser treatment systems, it would be advantageous to have a mechanism which automatically compensates for shifts in wavelength experienced by a laser beam, such as by temperature fluctuations of the diode providing such laser beam, so that a signal representative of the detected power output from a sampled portion of such laser beam is accurately provided and a desired power output of such system is able to be maintained. Moreover, such a mechanism would preferably have the ability to be adjusted or tuned in each optical bench, thereby permitting wider specifications on the device so that it can be fabricated more easily and less expensively.

### BRIEF SUMMARY OF THE INVENTION

In accordance with a first aspect of the present invention, an optical bench for processing laser light in a laser system is disclosed as including an optical bench housing, steering optics mounted within the optical bench housing for directing the laser light in a path from a laser light input to an output, and a first mechanism for monitoring power output of the laser light regardless of shifts in wavelength of the laser light. The steering optics includes a sampling filter mounted to the optical bench housing and positioned in the path of the laser light, wherein a first portion of the laser light is reflected to the output and a second portion of the laser light is transmitted to the first mechanism. The first mechanism further includes a correction filter for receiving the second laser light portion from the sampling filter, wherein a third portion of the laser light transmitted therethrough is adjusted to compensate for the wavelength shifts, and a power detector for receiving the third laser light portion and providing a signal representative of a detected power output for the laser light. Alternatively, the first mechanism further may include a correction filter for receiving the laser light, wherein an amount of the laser light transmitted therethrough is adjusted to compensate for shifts in wavelength of the laser light, a sampling filter mounted to the optical bench housing and positioned in the path of the transmitted laser light, wherein a first portion of the transmitted laser light is reflected to the output and a second portion of the transmitted laser light is transmitted through the sampling filter, and a power detector for receiving the second transmitted laser light portion and providing a signal representative of a detected power output for the laser light. The optical bench also may include a second mechanism for maintaining the power output of the laser light at a desired power output level.

In accordance with a second aspect of the present invention, a laser system is disclosed as including a diode for producing laser light, an optical fiber in optical communication with the laser light, an optical bench for directing the laser light from a laser light input to the optical fiber, and a first mechanism for monitoring power output of the laser light provided to the optical fiber regardless of fluctuations in temperature of the diode. The first mechanism further includes a sampling filter positioned in a path of the laser light, wherein the laser light is separated into a first portion and a second portion as a function of diode temperature, a correction filter for receiving the second laser light portion from the sampling filter, wherein a third portion of the laser light transmitted therethrough is adjusted to compensate the diode temperature fluctuations, and a power detector for receiving the third laser light portion and providing a signal representative of a detected power output for the laser light. The correction filter is preferably positioned at an angle of incidence other than 90° with an optical axis running longitudinally through the second laser light portion, but is movable with respect to the optical axis to adjust the angle of incidence therewith. The laser system further includes a second mechanism for maintaining the power output of the laser light provided to the optical fiber at a desired power output.

In accordance with a third aspect of the present invention, a method of monitoring power output of a laser beam in an optical system regardless of shifts in wavelength for the laser beam is disclosed as including the following steps: sampling a portion of the laser beam; adjusting the sampled laser beam portion to automatically compensate for any wavelength shifts of the laser beam; directing the adjusted sampled laser beam portion onto a power detector; and, providing a signal representative of a detected power output for the laser beam. The method may also include the step of maintaining the power output of the laser beam at a desired power output by providing a signal representative of the desired power output for the laser beam, supplying a power in response to the desired power output signal to a diode providing the laser beam, determining any difference between the desired power output signal and the detected power output signal, and modifying the power supplied to the diode in accordance with any difference between the desired power output signal and the detected power output signal.

In accordance with a fourth aspect of the present invention, an apparatus for monitoring power output of a laser beam in an optical system is disclosed as including a sampling filter positioned in a path of the laser beam, wherein the laser beam is separated into a first portion and a second portion as a function of a wavelength for the laser beam, a correction filter for receiving the second laser beam portion from the sampling filter, wherein a third portion of the laser beam transmitted therethrough is adjusted to compensate for fluctuations in the wavelength, and a power detector for receiving the third laser light portion and providing a signal representative of a detected power output for the laser beam. The apparatus may also include a mechanism for maintaining the power output of the laser beam provided by the optical system at a desired power output.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is an isometric view of a laser treatment system in accordance with the present invention having an optical fiber connectable thereto;

FIG. 2 is an isometric view of the laser treatment system of FIG. 1, where the cover has been removed so as to expose a controller board and the exterior of an optical bench therein;

FIG. 3 is a section view of the optical bench depicted in FIGS. 2, where the steering optics therein are in a normal operating position so as to allow a laser beam used for medical treatment procedures to pass through the optical bench and into the optical fiber;

FIG. 4 is an isometric view of the optical bench depicted in FIGS. 2 and 3, where a connect block and a printed circuit board are shown as being attached thereto; and

FIG. 5 is a schematic block diagram of circuitry in the laser treatment system utilized to monitor and control the power output of the treatment laser in accordance with the present invention.

### DETAILED DESCRIPTION OF THE INVENTION

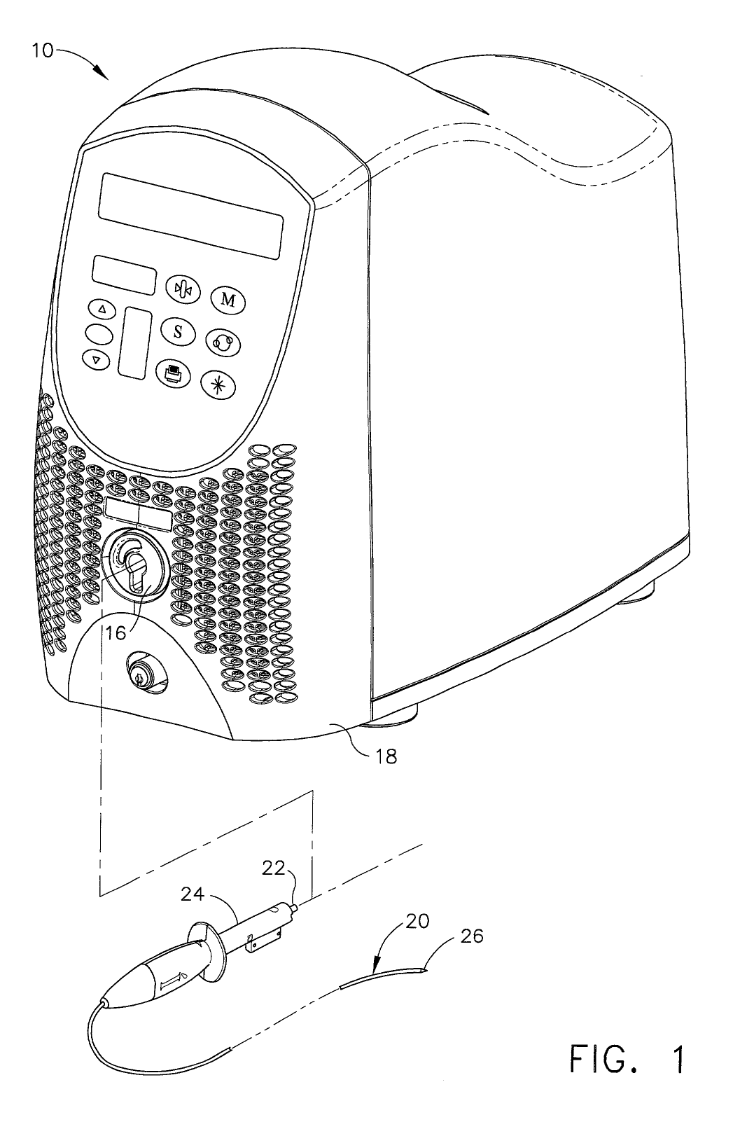

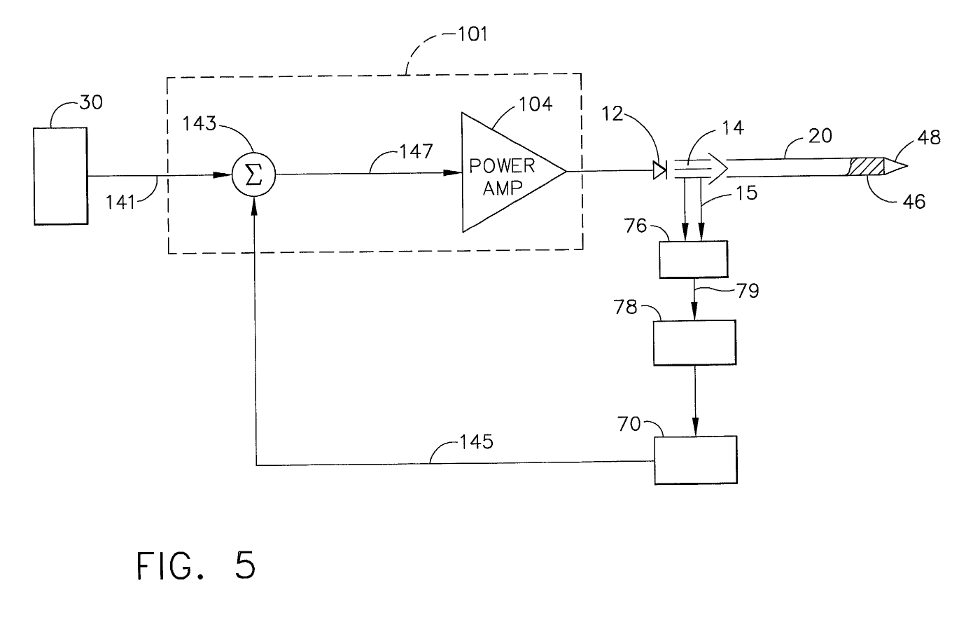

Referring now to the drawings in detail, wherein identical numerals indicate the same elements throughout the figures, FIG. 1 depicts a laser treatment system 10 for transferring energy to human tissue by means of light from an optical fiber 20. A first laser diode 12 is provided in laser treatment system 10 (see FIG. 5) to produce a first laser beam 14 having a predetermined power (preferably in a range of approximately 2-20 watts) and a predetermined wavelength (preferably in a range of approximately 800-850 nanometers) useful for the medical treatment of disease. As further seen in FIG. 1, a connect block 16 is located within a front portion of a housing 18 for laser treatment system 10. Connect block 16 assists first laser beam 14 to be optically linked with a first end 22 of optical fiber 20 via a connector 24 so that first laser beam 14 can be transmitted from a second end (or tip) 26 of optical fiber 20.

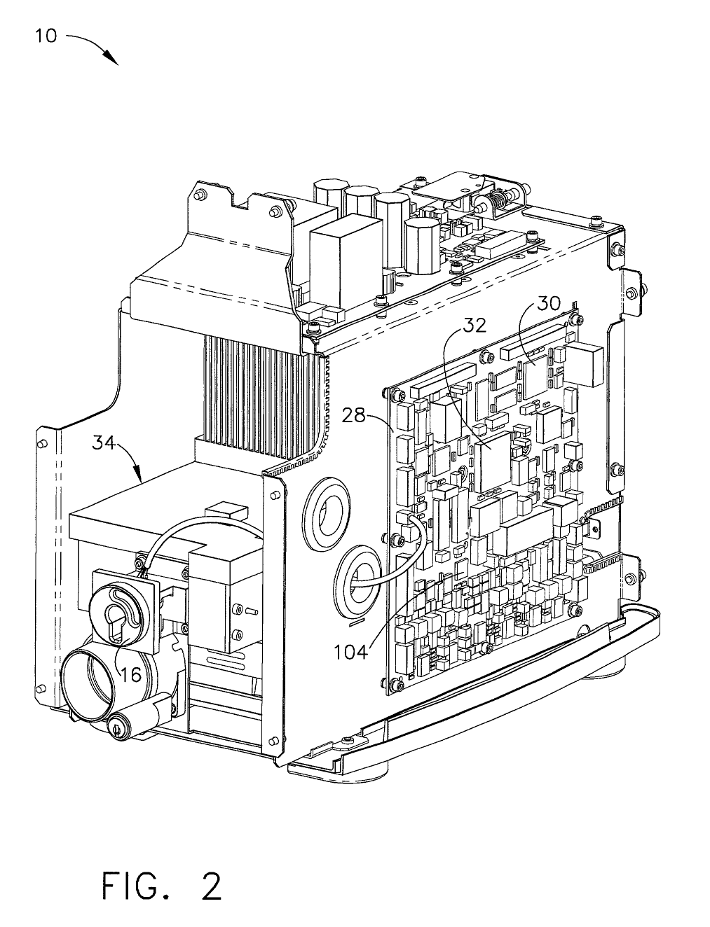

FIG. 2 depicts laser treatment system 10 with housing 18 removed so as to expose an optical bench, identified generally by reference numeral 34, in order to direct first laser beam 14 into optical communication with optical fiber first end 22 during normal operation. A controller board 28 is also shown that includes, among other components, a main processor 30 for receiving and processing electronic signals to control the operation of laser treatment system 10. Among other functions, main processor 30 operates to provide a desired power output signal 141 in a control loop described in greater detail herein.

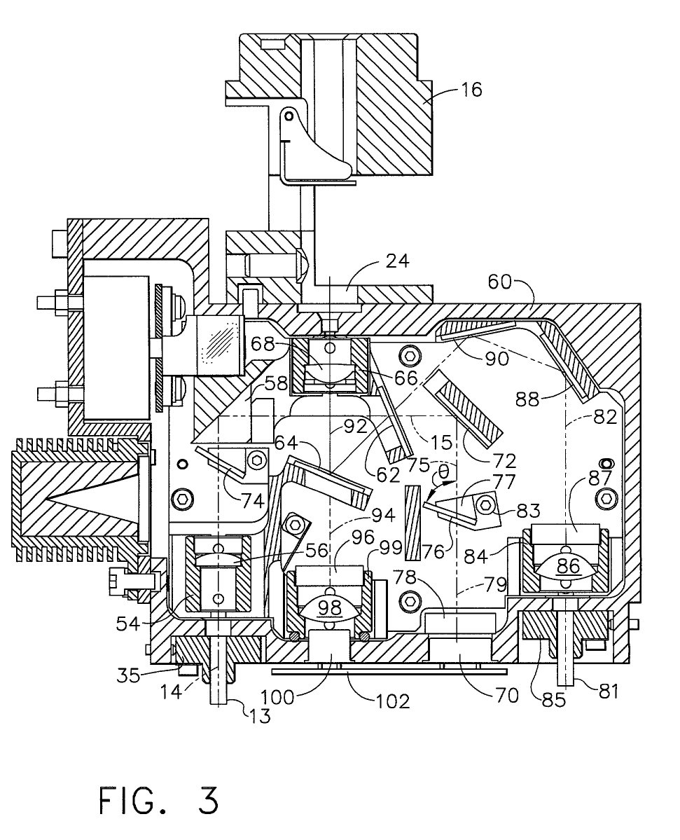

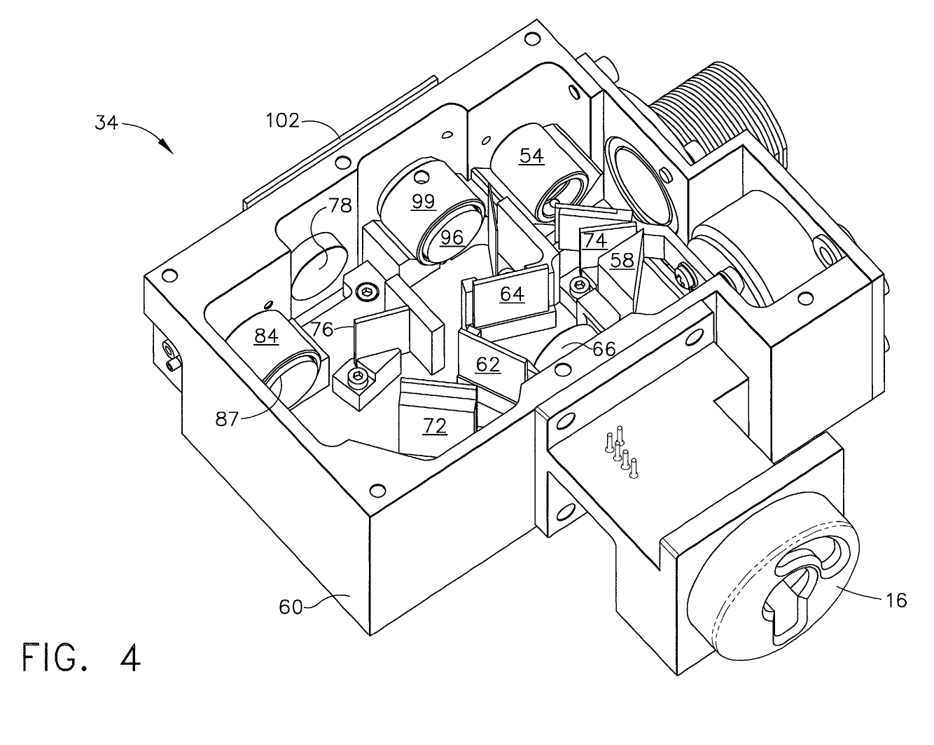

With regard to the operation of optical bench 34, it will be seen from FIGS. 3 and 4 that the path of first laser beam 14 enters optical bench 34 from an optical fiber 13 in optical communication with first laser diode 12. Optical fiber 13 is positioned within a connector 35 in optical bench 34 to assure proper alignment. First laser beam 14 is transmitted through a beam collimator 54 containing a lens 56 and is preferably directed toward a total internal reflection (TIR) prism 58 mounted to a housing 60 for optical bench 34. First laser beam 14 preferably reflects off TIR prism 58 and is received by a first beamsplitter 62, which reflects first laser beam 14 toward a second beamsplitter 64. First laser beam 14 is then reflected from second beamsplitter 64 through an output beam lens assembly 66 and an output lens 68 so as to place first laser beam 14 in optical communication with optical fiber first end 22 via connector 24.

Similarly, a second laser diode 80 preferably provides a second laser beam 82, also known herein as a marker laser beam, to optical bench 34 by means of an optical fiber 81. Optical fiber 81 is positioned within a connector 85 in optical bench 34 to assure proper alignment. Second laser beam 82 is transmitted through a marker beam collimator 84, a marker lens 86, and a marker filter 87 attached to optical bench housing 60. Marker laser beam 82 preferably has a predetermined power (preferably in a range of approximately 0.5-2 milliwatts) and a predetermined wavelength (preferably in a range of approximately 600-650 nanometers). It will be appreciated that marker laser beam 82 is preferably used as the light source to optically stimulate a fluorescent slug in optical fiber 20 so as to generate a desired optical fluorescent response therefrom. In order to place marker laser beam 82 in optical communication with optical fiber first end 22 via connector 24, it is directed toward a first laser turning mirror 88 which reflects it to a second laser turning mirror 90. Marker laser beam 82 then impacts first beamsplitter 62, which transmits most of marker laser beam 82 (as a function of its wavelength) so that it passes therethrough to second beamsplitter 64. Marker laser beam 82 then reflects off second beamsplitter 64 and through output beam lens assembly 66 and output lens 68. Accordingly, both first (treatment) laser beam 14 and second (marker) laser beam 82 are routed from first beamsplitter 62 to second beamsplitter 64, as indicated by reference numeral 92, into first end 22 of optical fiber 20 during normal operation of laser treatment system 10.

It will be appreciated that marker laser beam 82 provides an optical stimulus to the fluorescent slug in optical fiber second end 26, which absorbs the energy of marker laser beam 82 and fluoresces in response thereto. The time delay from stimulation of the fluorescent slug by marker laser beam 82 to the fluorescence of such fluorescent slug is a function of the temperature of optical fiber second end 26 and can be measured and used to calculate such temperature. The optical fluorescent response, indicated by reference numeral 94, is transmitted back through optical fiber 20 and out optical fiber first end 22 into optical bench 34. Optical fluorescent response 94 preferably has extremely low power (in a range of approximately 5-100 nanowatts) and has a preferred wavelength of approximately 680-780 nanometers. Optical fluorescent response 94 then passes through output lens 68 and output beam lens assembly 66 to second beamsplitter 64. Second beamsplitter 64 is constructed so that optical fluorescent response 94 is transmitted therethrough to a signal filter set 96, which functions to block any reflected marker and treatment light. The remaining signal, filtered to pass only the fluorescent and blackbody wavelengths, passes through a signal lens 98 and signal collimator 99 into a fluorescence/blackbody detector 100. It will be understood that the blackbody radiation returns along the same path as optical fluorescence signal 94, but is passed in a fourth waveband (approximately greater than 1500 nanometers) at extremely low power (in a range of approximately 0-100 nanowatts) through second beamsplitter 64. Florescence/blackbody detector 100 thus captures and analyzes this signal as a secondary temperature mechanism for a fail-safe mode, where blackbody radiation indicating a temperature too high for proper operation will shut down power to laser diode 12.

It will be appreciated that a small percentage (preferably on the order of 1%) of first laser beam 14 identified by reference numeral 15 is transmitted by first beamsplitter 62 (also known herein as a sampling filter) to a laser power detector 70 by means of a turning mirror 72 so that the power output of first laser beam 14 can be monitored and controlled. It will be understood that the percentage of first laser beam 14 transmitted by first beamsplitter 62 varies in a predictable fashion as a function of the wavelength of light being transmitted. This is due to the dielectric layers coated on first beamsplitter 62, as understood by one of ordinary skill in the art. Since the temperature of first laser diode 12 can vary between start-up and steady state operation of laser treatment system 10, the wavelength of first laser beam 14 will experience fluctuations or shifts corresponding thereto.

In order to account for diode temperature fluctuations and wavelength shifts, it is preferred that a correction filter 76 be mounted to optical bench housing 60 by a filter mount 77. The spectral response of correction filter 76 is preferably designed to complement that of first beamsplitter 62 so that the portion of first laser beam 14 transmitted therethrough to laser power detector 70 is a predetermined, substantially constant amount (indicated by reference numeral 79 as a third portion of first laser beam 14) with respect to the current wavelength therefor. The power output of laser light 79 detected by power laser detector 70 will therefore vary only with respect to the actual intensity of first laser diode 12 producing first laser beam 14. It will also be understood that the amount of laser light 79 transmitted through correction filter 76 is a function of the amount of laser light 15 transmitted by first beamsplitter 62 (and, therefore, indirectly of the wavelength for first laser beam 14 and the temperature of first laser diode 12).

It will also be appreciated that correction filter 76 is preferably positioned at an angle of incidence θ with respect to an optical axis 75 running longitudinally through laser light 15. In order to tune correction filter 76 in each optical bench 34, it is preferred that it be movable with respect to optical axis 75 to adjust angle of incidence θ with laser light 15. Accordingly, filter mount 77 may be repositioned by merely loosening a cap screw 83 holding filter mount 77 in place. It will be understood that correction filter 76 is preferably positioned at a non-normal angle of incidence θ (i.e., other than 90°) with respect to optical axis 75, whereby the degree of wavelength compensation may be adjusted either higher or lower by exposing such laser light 15 to a lesser or greater thickness of coating on correction filter 76.

A neutral density filter 78 is preferably provided between correction filter 76 and laser power detector 70. Filter 78 functions to diminish the intensity of laser light 79 in order to avoid overloading laser power detector 70.

It will be seen that a sensor board 102 is provided adjacent optical bench housing 60 so as to interface with fluorescence/blackbody detector 100 and laser detector 70. Circuitry on sensor board 102 is connected to and communicates with controller board 28 and main processor 30, as well as certain components located on a driver board 101. As seen in FIG. 5, main processor 30 provides a signal 141 to a summing device 143 on driver board 101 representative of a desired output power to be provided first laser diode 12. Summing device 143 also receives a signal 145 from laser power detector 70 representative of the detected output power from laser light 79. Accordingly, a signal 147 taking into account any difference or error between signals 141 and 145 is provided to a power amplifier 104, which then supplies the corresponding output power (i.e., drive current) to first laser diode 12. In this way, the power output of first laser beam 14 is able to be maintained at the desired level.

An alternate embodiment of correction filter 76 could also be employed if the laser light intensity transmitted to optical fiber 20 is not constant with wavelength, but varies with a known function. If, for example, beamsplitter 62 possessed a transmissibility versus wavelength function where the transmissibility varied considerably with wavelength, and the transmissibility was appreciable compared to the total light impinging upon it, the transmissibility versus wavelength function of the actual laser light transmitted through to optical fiber 20 would not be substantially constant. Accordingly, a substantially constant intensity versus wavelength M(λ) transmitted through to laser power detector 70 would not be preferred, but an M(λ) proportional to the intensity of light versus wavelength function R_{b}(λ) that is reflected from first beamsplitter 62 into optical fiber 20 is desirable. When laser power detector 70 receives light having an intensity versus wavelength function proportional to the function of the light sent to optical fiber 20, the proper power output to optical fiber 20 can accurately be maintained.

When a function R_{b}(λ) is reflected into optical fiber 20, the function T_{b}(λ)=1-R_{b}(λ) is transmitted through to correction filter 76. In order to ensure the function M(λ) impinging upon laser power detector 70 accurately represents power to optical fiber 20, M(λ) should be proportional to T_{b}(λ). This proportionality yields M(λ)=K*T_{b}(λ). The correction function T_{c}(λ) can then be calculated by knowing that the correction function T_{c}(λ) times the function transmitted to correction filter 76 T_{b}(λ) should be proportional to the light intensity to the optical fiber, R_{b}(λ), or R_{b}(λ)=K*T_{c}(λ)*T_{b}(λ). The function for correction filter 76 can then be specified as T_{c}(λ)=R_{b}(λ)/(K*T_{b}(λ)).

It will be noted that K is a constant and thus can be evaluated at any wavelength. For example, a nominal wavelength λₙ may be chosen so that K can be evaluated at a given λₙ, or K=R_{b}(λₙ)/[T_{c}(λₙ)*T_{b}(λₙ)], where T_{c}(λₙ) represents the transmissibility of correction filter 76 at the nominal wavelength. In this way, T_{c}(λₙ) can be chosen to create a practical, producable function T_{c}(λ) for correction filter 76.

It should be noted that if light intensity directed into optical fiber 20 as a function of wavelength R_{b}(λ) is substantially constant, the function for correction filter 76 degenerates into T_{c}(λ)=1/K*T_{b}(λ). Assuming M(λ) to be substantially constant, this expression for T_{c}(λ) describes the special case disclosed hereinabove.

Using methods and devices disclosed, a person of ordinary skill in the art could specify any desired wavelength versus intensity function and not necessarily a function that is substantially proportional to the function of the light traveling to connector 24. This function could correct for waveband shifts and tolerances in many optical and electrical parts within laser treatment system 10, such as, but not limited to, filters, laser diodes, detectors, or other electronic parts. In this way, correction filter 76 could modify the wavelength of light to correct for shifts caused by variables other than the temperature of first laser diode 12. Correction filter 76 may possess any wavelength versus intensity function to modify light in the beampath so that the calculations of main processor 30 correlate to intensity and power of the output laser light.

It will be recognized that equivalent structures may be substituted for the structures illustrated and described herein and that the described embodiment of the invention is not the only structure that may be employed to implement the claimed invention. In particular, correction filter 76 may be positioned in the path of first laser beam 14 prior to transmittance by first beamsplitter 62. This embodiment causes the amount of first laser beam 14 to be transmitted by correction filter 76 to be pre-adjusted according to the spectral response of first beamsplitter 62. Nevertheless, the amount of first laser beam 14 provided to laser power detector 70 has been calibrated for any shift in wavelength thereof. It will also be appreciated that the beampath of optical bench 34 may be arranged so that first beamsplitter 62 transmits light into optical fiber 20 and uses reflected light instead of transmitted light to monitor laser intensity. In this case, where optical fiber 20 receives transmitted light instead of reflected light, a similar derivation yields T_{c}(λ)=T_{b}(λ)/R_{b}(λ)*K.

As a further example of equivalent structures, if losses elsewhere in laser treatment system 10 modify the intensity versus wavelength function directed to optical fiber 20, correction filter 76 may also be modified accordingly to create an intensity versus wavelength function of light received by laser power detector 70. Multiple correction filters may be used, if desired, and may alternatively be placed in the laser output beampath rather than in the path of laser light traveling to laser power detector 70.

While preferred embodiments of the present invention have been shown and described herein, it will be obvious to those skilled in the art that such embodiments are provided by way of example only. Numerous variations, changes, and substitutions will now occur to those skilled in the art without departing from the invention. Accordingly, it is intended that the invention be limited only by the spirit and scope of the appended claims.

What is claimed is:

1. An optical bench for processing laser light in a laser system, comprising:
(a) an optical bench housing;
(b) steering optics mounted within said optical bench housing for directing said laser light in a path from a laser light input to an output; and
(c) a first mechanism for monitoring power output of said laser light regardless of shifts in wavelength of said laser light.

2. The optical bench of claim 1, wherein said shifts in wavelength of said laser light are automatically compensated for by said first mechanism so as to provide a signal representative of a detected power output for said laser light at said output.

3. The optical bench of claim 1, said steering optics further comprising a sampling filter mounted to said optical bench housing and positioned in the path of said laser light, wherein a first portion of said laser light is reflected to said output and a second portion of said laser light is transmitted to said first mechanism.

4. The optical bench of claim 3, wherein respective amounts for said first and second laser light portions as a percentage of said laser light are a function of wavelength for said laser light.

5. The optical bench of claim 3, wherein respective amounts for said first and second laser light portions as a percentage of said laser light are a function of a temperature for a diode producing said laser light.

6. The optical bench of claim 3, said first mechanism further comprising:
(a) a correction filter for receiving said second laser light portion from said sampling filter, wherein a third portion of said laser light transmitted therethrough is adjusted to compensate for said wavelength shifts; and
(b) a power detector for receiving said third laser light portion and providing a signal representative of a detected power output for said laser light.

7. The optical bench of claim 6, wherein the amount of said third laser light portion transmitted to said power detector is substantially constant with respect to shifts in wavelength for said laser light.

8. The optical bench of claim 6, wherein said correction filter is positioned at a non-normal angle of incidence with respect to an optical axis running longitudinally through said second laser light portion.

9. The optical bench of claim 8, wherein said correction filter is movable with respect to said optical axis to adjust said angle of incidence therewith.

10. The optical bench of claim 9, wherein the degree of wavelength compensation provided by said correction filter is a function of the angle of incidence for said correction filter with respect to said optical axis.

11. The optical bench of claim 6, wherein intensity of said third laser light portion transmitted to said power detector varies only with respect to actual intensity of a diode providing said laser light.

12. The optical bench of claim 6, said first mechanism further comprising a neutral density filter positioned between said correction filter and said power detector, wherein intensity of said third laser light portion is adjusted to avoid overloading said power detector.

13. The optical bench of claim 1, said first mechanism further comprising:
(a) a correction filter for receiving said laser light, wherein an amount of said laser light transmitted therethrough is adjusted to compensate for shifts in wavelength of said laser light;
(b) a sampling filter mounted to said optical bench housing and positioned in the path of said transmitted laser light, wherein a first portion of said transmitted said laser light is reflected to said output and a second portion of said transmitted laser light is transmitted through said sampling filter; and
(c) a power detector for receiving said second transmitted laser light portion and providing a signal representative of a detected power output for said laser light.

14. The optical bench of claim 2, further comprising a second mechanism for maintaining the power output of said laser light at a desired power output.

15. The optical bench of claim 14, said second mechanism further comprising:
(a) a driver board for supplying power to a diode providing said laser light; and
(b) a processor for providing a signal representative of said desired power output for said laser light to said driver board;
wherein said driver board receives said detected power output signal and modifies the amount of power supplied to said diode according to any difference between said detected and desired power output signals.

16. A laser system, comprising:
(a) a diode for providing laser light;
(b) an optical fiber in optical communication with said laser light;
(c) an optical bench for directing said laser light from a laser light input to said optical fiber; and
(d) a first mechanism for monitoring power output of said laser light provided to said optical fiber regardless of fluctuations in temperature of said diode.

17. The laser system of claim 16, wherein said fluctuations in temperature of said diode are automatically compensated for by said first mechanism so as to provide a signal representative of a detected power output for said laser light at said output.

18. The laser system of claim 16, said first mechanism further comprising:
(a) a sampling filter positioned in a path of said laser light, wherein said laser light is separated into a first portion and a second portion as a function of diode temperature;
(b) a correction filter for receiving said second laser light portion from said sampling filter, wherein a third portion of said laser light transmitted therethrough is adjusted to compensate for said diode temperature fluctuations; and
(c) a power detector for receiving said third laser light portion and providing a signal representative of a detected power output for said laser light.

19. The laser system of claim 18, wherein respective amounts of said first and second laser light portions as a percentage of said laser light are a function of a temperature for said diode providing said laser light.

20. The laser system of claim 18, wherein intensity of said third laser light portion transmitted to said power detector varies only with respect to actual intensity of said diode providing said laser light.

21. The laser system of claim 18, said first mechanism further comprising a neutral density filter positioned between said correction filter and said power detector, wherein intensity of said third laser light portion is adjusted to avoid overloading said power detector.

22. The laser system of claim 18, wherein said correction filter is positioned at a non-normal angle of incidence with an optical axis running longitudinally through said second laser light portion.

23. The laser system of claim 22, wherein said correction filter is movable with respect to said optical axis to adjust said angle of incidence therewith.

24. The laser system of claim 23, wherein the degree of wavelength compensation provided by said correction filter is a function of the angle of incidence for said correction filter with respect to said optical axis.

25. The laser system of claim 16, said first mechanism further comprising:
(a) a correction filter positioned for receiving said laser light, wherein an amount of said laser light transmitted therethrough is adjusted to compensate for fluctuations in temperature of said diode;
(b) a sampling filter positioned in the path of said transmitted laser light, wherein a first portion of said transmitted laser light is reflected to said optical fiber and a second portion of said transmitted laser light is transmitted through said sampling filter; and
(c) a power detector for receiving said second transmitted laser light portion and providing a signal representative of a detected power output for said laser light provided to said optical fiber.

26. The laser system of claim 16, further comprising a second mechanism for maintaining the power output of said laser light provided to said optical fiber at a desired power output.

27. The laser system of claim 26, said second mechanism further comprising:
(a) a driver board for supplying power to said diode; and
(b) a processor for providing a signal representative of said desired power output for said laser light to said driver board;
wherein said driver board receives said detected power output signal and modifies the amount of power supplied to said diode according to any difference between said detected and desired power output signals.

28. A method of monitoring power output of a laser beam in an optical system regardless of shifts in wavelength for said laser beam, comprising the following steps:
(a) sampling a portion of said laser beam;
(b) adjusting the sampled laser beam portion to automatically compensate for any wavelength shifts of said laser beam;
(c) directing said adjusted sampled laser beam portion onto a power detector; and
(d) providing a signal representative of a detected power output for said laser beam.

29. The method of claim 28, further comprising the step of maintaining the power output of said laser beam at a desired power output.

30. The method of claim 29, said maintaining step further comprising the following steps:
(a) providing a signal representative of said desired power output for said laser beam;
(b) supplying a power in response to said desired power output signal to a diode providing said laser beam;
(c) determining any difference between said desired power output signal and said detected power output signal; and
(d) modifying the power supplied to said diode in accordance with any difference between said desired power output signal and said detected power output signal.

31. An apparatus for monitoring power output of a laser beam in an optical system regardless of shifts in wavelength for said laser beam, comprising:
(a) a sampling filter positioned in a path of said laser beam, wherein said laser beam is separated into a first portion and a second portion as a function of a wavelength for said laser beam;
(b) a correction filter for receiving said second laser beam portion from said sampling filter, wherein a third portion of said laser light transmitted therethrough is adjusted to compensate for shifts in said wavelength; and
(c) a power detector for receiving said third laser light portion and providing a signal representative of a detected power output for said laser beam.

32. The apparatus of claim 31, further comprising a mechanism for maintaining the power output of said laser light provided by said optical system at a desired power output.

33. The apparatus of claim 32, said mechanism further comprising:
(a) a driver board for supplying power to a diode providing said laser beam; and
(b) a processor for providing a signal representative of said desired power output for said laser beam to said driver board;
wherein said driver board receives said detected power output signal and modifies the amount of power supplied to said diode according to any difference between said detected and desired power output signals.
